(19) United States
(12) Patent Application Publication
(10) Pub. No.: US 2013/0103597 A1
(43) Pub. Date: Apr. 25, 2013

(54) EVALUATING APPRAISALS BY COMPARING THEIR COMPARABLE SALES WITH COMPARABLE SALES SELECTED BY A MODEL

(71) Applicants: Hamilton Fout, Rockville, MD (US); Eric Rosenblatt, Derwood, MD (US); Vincent Yao, Rockville, MD (US); Benjamin Hoffman, Washington, DC (US); Matthew David Mokey, Arlington, VA (US)

(72) Inventors: Hamilton Fout, Rockville, MD (US); Eric Rosenblatt, Derwood, MD (US); Vincent Yao, Rockville, MD (US); Benjamin Hoffman, Washington, DC (US); Matthew David Mokey, Arlington, VA (US)

(73) Assignee: Fannie Mae, Washington, DC (US)

(21) Appl. No.: 13/279,739

(22) Filed: Oct. 24, 2011

(51) Int. Cl. G06Q 50/16

(52) U.S. Cl. 705/313

(57) ABSTRACT

Automatically rating appraisal quality and evaluating comparables listed on the appraisal. A comparable selection model selects control comparables using transaction data and property characteristics relative to a subject from a database. An evaluation model compares the control comparables to the listed comparables to generate a quality rating for the appraisal based on category scores that result from an appraisal evaluation over a set of categories.

### BACKGROUND OF THE INVENTION

1. Field of the Invention

This application relates generally to appraisal valuations, more particularly to the valuation of appraisals based on the comparable sales listed on the appraisals, and still more particularly to comparing the comparables sales listed on the appraisals to those selected by a comparable selection model.

2. Description of the Related Art

What is needed is an appraisal rating model and the like that evaluates the individual comparable sales (comps) listed on an appraisal to verify that the appraisal meets a relative standard of accuracy for home evaluation for a geographic region.

Determining whether a property is appropriately valued, whether accurate comparables sales are selected for said valuation, or whether the relative value of a home or property is congruent to other properties in a geographic region is very difficult without extensive knowledge of a particular property, the surrounding areas, and the relative history of that property. Appraisers themselves and the appraisals they render are currently the main source for property values.

Yet, while most appraisals can be assumed to be accurate, performing quality assurance on appraisals requires another appraiser to perform a second evaluation on a property to prove that the first appraisal was an accurate evaluation. In addition, due to the required extensive knowledge as detailed above, the limited human ability to analyze and compute such information, and the length of time required by human evaluations, automatic verification possesses a public benefit. And since there is no current method for automatic verification of an appraisal, the below described invention offers and details a faster way to judge appraisal quality without the need for additional human evaluations and appraisals.

### SUMMARY OF THE INVENTION

The present invention relates to a method for an automatic quality rating of appraisal selected comparables that comprises creating a comparable list through selecting control comparables by a comparable selection model based on a subject property and adding the appraisal selected comparables to the control comparables; ranking the comparable list using category comparisons; and displaying the ranked list via a display device.

Further, the comparable selection model may select the set of control comparables using transaction data and property characteristics relative to the subject. Ranking the comparable list using category comparisons may also comprise generating, for each comparable in the comparable list, a set of scores where each score is relative to a category in a category set, wherein the category set includes comparable selection, comparable adjustment, comparable weighting, and final valuation.

Furthermore, generating the category score for the comparable selection category may be based on how closely the control comparables and the appraisal selected comparables match in terms of explanatory variables. The explanatory variables may include property characteristics, distance from subject, age of comparable sale, price distribution, and rank ordering. Generating the category score for the comparable adjustment category may be based on the difference between adjustments made to the appraisal selected comparables and adjustments made by the comparable selection model to the control comparables. Generating the category score for the comparable weighting category may be based on a comparison of a weighting of each appraisal selected comparable based on how closely each appraisal selected comparable matches an appraisal valuation to a weighting of each control comparable based on how closely each control comparable matches the appraisal valuation. Generating the category value for the final valuation category may be based on how closely a final valuation of the subject by the appraisal using the appraisal selected comparables matches a final valuation of the subject by the comparable selection model using the control comparables.

Also, the method may comprise automatically rating a quality of each appraisal in a set of appraisals, wherein each appraisal of the set of appraisals is segregated based on its respective quality rating into quintiles or other groups, which may be user defined, and wherein the segregating is based on the automatic quality rating of appraisal selected comparables.

An alternative embodiment may include a computer program product stored on a non-transitory computer readable medium that when executed by a computer performs a method for automatically rating a quality of an appraisal and an apparatus that automatically rates a quality of appraisal selected comparables comprising a circuit that creates a comparable list by selecting control comparables based on a subject via a comparable selection model, extracting the appraisal selected comparables from an appraisal, and adding the appraisal selected comparables to the control comparables, and that ranks the comparable list using category comparisons; and a display that displays the ranked list.

Another alternative embodiment may be include apparatus that automatically rates a quality of appraisal selected comparables using a circuit that creates a comparable list by selecting control comparables based on a subject via a comparable selection model, extracting the appraisal selected comparables from an appraisal, and adding the appraisal selected comparables to the control comparables and that ranks the comparable list using category comparisons; and a display that displays the ranked list.

Another alternate embodiment may include rendering an appraisal scorecard when an appraisal is received by executing a data integrity check on the appraisal, evaluating the appraisal if the appraisal passes the data integrity check by running the appraisal through a comparable selection model and a value confidence model, and rating the appraisal based on the appraisal evaluation and pass/fail thresholds, wherein evaluating the appraisal includes generating for each comparable identified by the comparable selection model and the value confidence model scores that are relative to a category set, which includes comparable selection, comparable adjustment, comparable weighting, and final valuation.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIGS. 1A-B are block diagrams illustrating examples of systems in which an evaluation application operates.

FIG. 2 is a flow diagram illustrating an example of a process for modeling comparable properties.

FIG. 3 is a flow diagram illustrating an example of modeling and mapping comparable properties.

FIG. 4 is a flow diagram illustrating a process for evaluating a group of appraisals and segregating the evaluated appraisals into quintiles.

FIG. 5 is a block diagram illustrating an example of an evaluation application.

FIG. 6 is a block diagram illustrating an example of an evaluation application with geographic feature proximity determination.

FIG. 7 is a block diagram illustrating an example of an evaluation application process.

### DETAILED DESCRIPTION OF THE INVENTION

In the following description, for purposes of explanation, numerous details are set forth, such as flowcharts and system configuration, to provide an understanding of one or more embodiments. However, it is and will be apparent to one skilled in the art that these specific details are not required to practice the described.

According to one aspect, the present invention uses a model (for example, see the comparable selection model below) to select the best comparable sales for a property based on transaction level data that includes property characteristics and compares those model sales to the comparable sales selected for use in an appraisal. The appraisal is given a score based on how well the appraisal's comparable sales compare to the model-selected comparables sales in categories that drive the value of properties.

For example, for each given appraisal, the invention produces an appraisal scorecard that generates a score from 1 (best) to 5 (worst) using inputs from input sources. The score may be used to detect potential defects with each given appraisal or as an input into a Rep & Warrant Model. The inputs or evaluation dimensions may include comparable selection, comparable adjustment, comparable weighting, and final evaluation. The input sources, from which the evaluation dimensions are drawn, may include a comparable selection model (CSM), a Value Confidence Model (VCM), and the 1004 uniform Residential Form (appraisal). The CSM provides an alternative view of the sales comparison approach used by appraisers. The VCM provides a measure of how reliable the CSM is for a particular property and thus whether the Appraisal Scorecard using output from the CSM can be used to evaluate an appraisal on the property.

Regarding the evaluation dimensions, when evaluating the comparable selection in the appraisal, the model assigns a score in this category by finding how closely appraisal selected comparables and model selected comparables match in terms of property characteristics, distance from subject, age of comparable sale, price distribution, and rank ordering. Further, the comparable adjustments in appraisals are measured relative to adjustments from the CSM. That is, the greater differences in the magnitude of adjustments will have lower scores. Concerning scoring methodology, comparables are more heavily weighted when the comparables more closely match the final valuation of the appraisal. That is, weighting is calculated for each comparable property and then compared to the CSM weighting. The weightings from the appraisal and the CSM are compared, and scores are assigned appropriately. Furthermore, the final valuation from the appraisal is also compared to the CSM, such that appraisals that more closely match the CSM final valuation may receive higher scores.

In other words, the present invention gauges appraiser performance along the dimensions of comparable selection/comparable weighting, comparable adjustment and final valuation from variables produced from the appraisal, VCM, and CSM.

### Comparable Selection Model

A subject property is identified, and a set of value adjustments is automatically determined based upon differences in the explanatory variables between the subject property and each of a plurality of comparable properties, with the set of value adjustments including a determination of the proximity to the geographic feature(s) for the subject property and the plurality of comparable properties. A value for the subject property is then estimated based upon the set of value adjustments.

In one example, only those properties bordering a geographic feature are considered to be sufficiently proximate to the geographic feature. In other examples, distance may be used as a metric for determining sufficient proximity to the geographic feature, potentially with further examination to identify bordering properties. Proximate properties may have an associated adjustment factor, while bordering properties may have another adjustment factor.

In one example, the determination of proximity entails accessing map data that provides a shape for the geographic feature, as well as for parcels corresponding to a subject property and comparable properties. The shape for the geographic feature is expanded, and then candidate parcels for proximity (e.g., bordering) are identified based upon whether the expanded shape overlaps the parcels corresponding to the properties.

Border logic may be applied to identify property parcels bordering the geographical feature. This, for example, may entail examining line(s) extending between location(s) designated for the geographic feature and location(s) designated for the parcels of candidate comparable properties. For example, bordering may be found where no intervening non-excluded parcel is present along the line between the geographic feature and the parcel for the candidate comparable property. In a more specific example, bordering may be found where no intervening non-excluded parcel is present along a line between a centroid of the parcel of the candidate comparable property and a midpoint of lines constituting the shape for the geographic feature. Still further, bordering proximity may be found where no intervening non-excluded parcel is present along lines between mid-points of the sides of the parcel of the candidate comparable property and a midpoint of lines constituting the shape for the geographic feature.

The regression modeling may vary, but in one example the property data is accessed and a regression models the relationship between price and explanatory variables (including at least one explanatory variable for geographic feature). For example, a hedonic regression is performed at a geographic level (e.g., county) sufficient to produce reliable results. A pool of comparables is identified, such as by initial exclusion rules based upon distance from and other factors in relation to a subject property. A set of adjustments for each comparable is determined using adjustment factors drawn from the regression analysis. The comparables may then be weighted and displayed.

Various types of explanatory variable scenarios for the geographic feature may also be implemented. In one example, the explanatory variable for proximity to the geographic feature is a categorical variable, with proximity determined only when the subject property borders the geographic feature. As another example, the explanatory variable for proximity to the geographic feature depends upon the physical distance between the subject property and the geographic feature.

A map image is displayed to illustrate the geographic distribution of the subject property and the comparable properties. An associated grid details information about the subject and comparable properties. The grid can be sorted according to a variety of property and other characteristics, and operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

### (i) Hedonic Equation

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention. In addition, due to a lack of data, a property condition effect may not be part of the current hedonic price and comparable sales models. However, the condition of the property at the time of transaction has been proven to be an important factor in determining the sale price. This factor and method of determining are described below.

In this hedonic example, the dependent variable is the logged sale price. The explanatory variables are:

(1) Four continuous property characteristics:
(a) log of gross living area (GLA),
(b) log of Lot Size,
(c) log of Age, and
(d) Number of Bathrooms; and

(2) Four fixed effect variables:
(a) location fixed effect (e.g., by Census Block Group (CBG));
(b) Time fixed effect (e.g., measured by 3-month periods (quarters) counting back from the estimation date);
(c) Foreclosure status fixed effect, which captures the maintenance condition and possible REO discount; and
(d) Feature Border, which captures whether the property borders a geographical feature of interest (e.g., body of water).

The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + {\sum }_{j = \{ 0 , 1 \}} {BF}_{j} + ɛ \qquad ( Eq . 1 )$$

The above equation is offered as an example, and as noted, there may be departures. For example, although CBG is used as the location fixed effect, other examples may include Census Tract or other units of geographic area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

### (ii) Exclusion Rules

Comparable selection rules are then used to narrow the pool of comps to exclude the properties which are determined to be insufficiently similar to the subject.

A comparable property should be located in a relative vicinity of the subject and should be sold relatively recently; it should also be of similar size and age and sit on a commensurate parcel of land. The “N” comparables that pass through the exclusion rules are used for further analysis and value prediction.

For example, the following rules may be used to exclude comparables pursuant to narrowing the pool:
(1) Neighborhood: comps must be located in the Census Tract of the subject and its immediate neighboring tracts;
(2) Time: comps must be sales within twelve months of the effective date of appraisal or sale;
(3) GLA must be within a defined range, for example:

$$\frac{2}{3} \leq \frac{{GLA}_{S}}{{GLA}_{C}} \leq \frac{3}{2}$$

(4) Age similarity may be determined according to the following Table 2:

TABLE 2

| Subject Age | 0-2 | 3-5 | 6-10 | 11-20 | 21-40 | 41-65 | 65+ |
|---|---|---|---|---|---|---|---|
| Acceptable | 0-5 | 0-10 | 2-20 | 5-40 | 11-65 | 15-80 | 45+ |
| Comp Age | | | | | | | |

(5) Lot size similarity may be determined according to Table 3:

TABLE 3

| | | | | |
|---|---|---|---|---|
| Subject | <2000 sqft | 2000-4000 | 4000 sqft-3acres | >3 acres |
| Lot size | | sqft | | |
| Acceptable Comp Lot | 1-4000 sqft | 1-8000 sqft | $\frac{2}{5} \leq \frac{{LOT}_{S}}{{LOT}_{C}} \leq \frac{5}{2}$ | >1 acre |

These exclusion rules are provided by way of example. There may be a set of exclusion rules that add variables, that omit one or more the described variables, or that use different thresholds or ranges.

(iii) Adjustment of Comps

Given the pool of comps selected by the model, the sale price of each comp may then be adjusted to reflect the difference between a given comp and the subject in each of the characteristics used in the hedonic price equation.

For example, individual adjustments are given by the following equation set (2):

A_{gla}=exp└(ln(GLA_{S})−ln(GLA_{C}))·β_{gla}┘;

Aₗₒₜ=exp[[(ln(LOT_{S})−ln(LOT_{C}))·βₗₒₜ];

A_{age}=exp└(ln(AGE_{S})−ln(AGE_{C}))·β_{age}┘;

A_{bath}=exp└(BATH_{S}−BATH_{C})·β_{age}┘;

A_{loc}=exp[LOC_{S}−LOC_{C}];

Aₜᵢₘₑ=exp[TIME_{S}−TIME_{C}];

A_{fcl}=exp[FCL_{S}−FCL_{C}]; and

A_{fcl}=exp[BF_{S}−BF_{C}], (Eq. 2)

where coefficients βgla, βlot, βage, βbath, LOC, TIME, FCL, and BF are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl , bf \}} {A}_{i} = {p}_{C} \cdot {A}_{TOTAL} \qquad ( Eq . 3 )$$

### (iv) Weighting of Comps and Value Prediction

Because of unknown neighborhood boundaries and potentially missing data, the pool of comparables will likely include more than are necessary for the best value prediction in most markets. The adjustments described above can be quite large given the differences between the subject property and comparable properties. Accordingly, rank ordering and weighting are also useful for the purpose of value prediction.

The economic distance D_{eco} between the subject property and a given comp may be described as a function of the differences between them as measured in dollar value for a variety of characteristics, according to the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl , bf \}} {( {A}_{i} - 1 )}^{2}} \qquad ( Eq . 4 )$$

The comps are then weighted. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} , \qquad ( Eq . 5 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi ,\end{matrix} \qquad ( Eq . 6 )$$

and dT is a down-weighting age of comp sale factor

$${dT}_{SC} = \{ \begin{matrix}1.00 & if ( 0 , 90 ] days \\ 1.25 & if ( 90 , 180 ] days \\ 2.00 & if ( 180 , 270 ] days \\ 2.50 & if ( 270 , 365 ] days .\end{matrix} \qquad ( Eq . 7 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} . \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

### Evaluation Application

According to one aspect, the present invention may be preferably provided as an application or as software, yet it may alternatively be hardware, firmware, or any combination of software, hardware and firmware. Further, an application constructed via software that is stored on a non-transitory computer readable medium may either integrate a comparable selection model or pull data from the comparable selection model to select the best comparable sales and compare those model sales to the comparable sales selected for use in an appraisal. All the comparables themselves will then be ranked by the application, and the result of the rankings may be output to a printer, display, or the like. Furthermore, the appraisal may be given a score based on how well the appraisal's comparable sales compare to the model-selected comparables sales in categories that drive the value of properties.

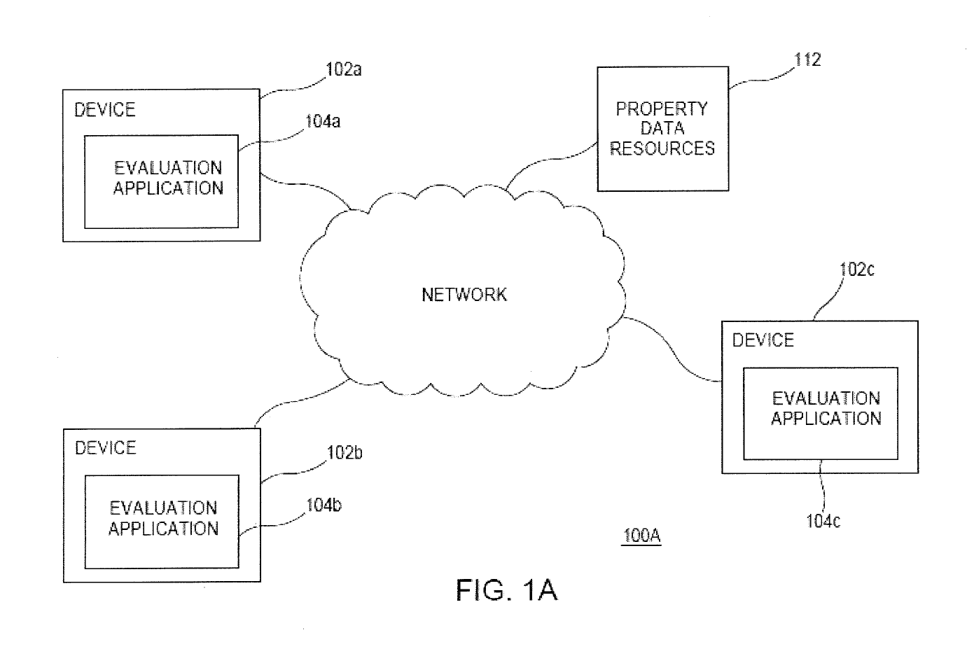

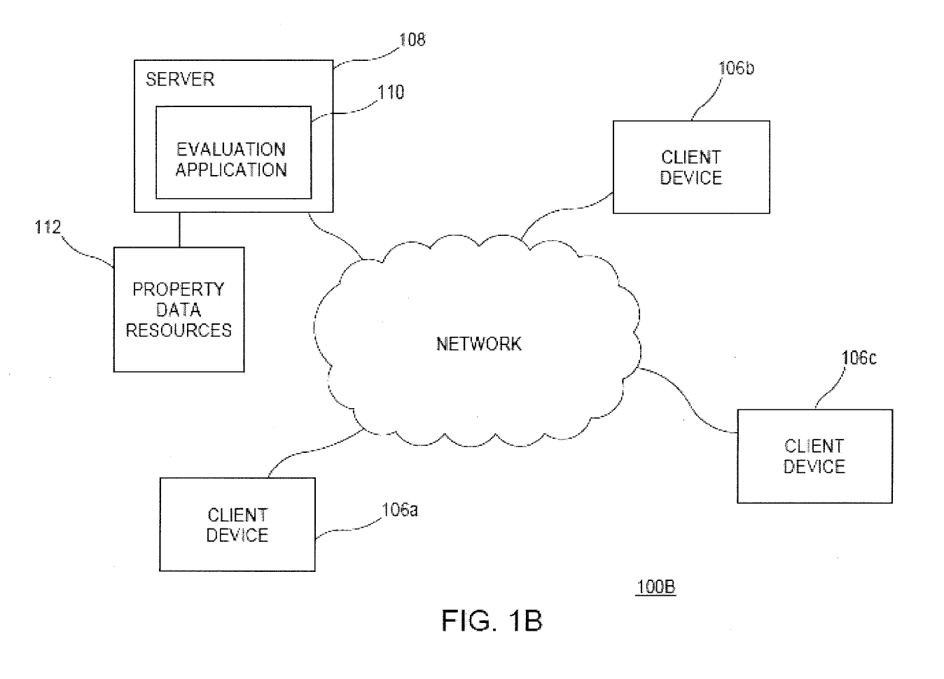

FIGS. 1A-B are block diagrams illustrating examples of systems in which an evaluation application operates. Specifically, FIGS. 1A-B are block diagrams illustrating examples of systems 100A-B in which an evaluation application operates.

FIG. 1A illustrates several user devices 102a-c each having an evaluation application 104a-c. The user devices 102a-d are preferably computer devices, which may be referred to as workstations, although they may be any conventional computing or electronic devices, such as personal computers, laptop personal computers, mobile phones, smart-phones, super-phones, tablet personal computers, personal digital organizers and the like. The network over which the devices 102a-d may communicate may also implement any conventional technology, including but not limited to cellular, WiFi, WLAN, LAN, or combinations thereof.

In one embodiment, the evaluation application 104a-c is an application that is installed on the user device 102a-c. For example, the user device 102a-c may be configured with a web browser application, with the application configured to run in the context of the functionality of the browser application. This configuration may also implement a network architecture wherein the evaluation applications 104a-c provide, share and rely upon the evaluation application 104a-c functionality.

As an alternative, as illustrated in FIG. 1B, the computing devices 106a-c may respectively access a server 108, such as through conventional web browsing, with the server 108 providing the evaluation application 110 for access by the client computing devices 106a-c. As another alternative, the functionality may be divided between the computing devices and server. Finally, of course, a single computing device may be independent configured to include the evaluation application.

As illustrated in FIGS. 1A-B, property data resources 112 are typically accessed externally for use by the evaluation application, since the amount of property data is rather voluminous, and since the application is configured to allow access to any county or local area in a very large geographic area (e.g., for an entire country such as the United States). Additionally, the property data resources 112 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The evaluation application accesses and retrieves the property data from these resources in support of the modeling of comparable properties as well as the rendering of map images of subject properties and corresponding comparable properties, and the display of supportive data (e.g., in grid form) in association with the map images.

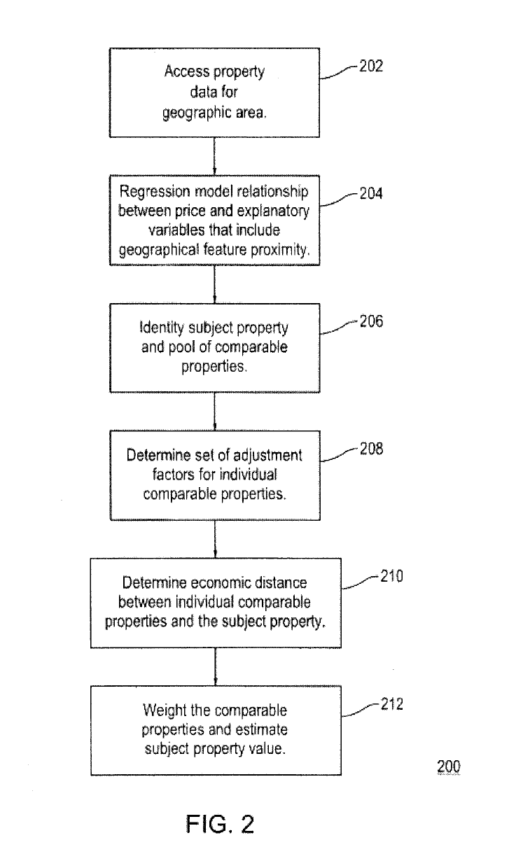

FIG. 2 is a flow diagram illustrating an example of a process for modeling comparable properties. Specifically, FIG. 2 is a flow diagram illustrating an example of a process 200 for modeling comparable properties, which may be performed by an aspect of the evaluation application or the comparable selection model (CSM) itself.

As has been described, the application accesses 202 property data. This is preferably tailored at a geographic area of interest in which a subject property is located (e.g., county). A regression 204 modeling the relationship between price and explanatory variables is then performed on the accessed data. Although various alternatives may be applied, a preferred regression is that described above, wherein the explanatory variables are the four property characteristics (GLA, lot size, age, number of bathrooms, border feature status) as well as the categorical fixed effects (location, time, foreclosure status).

A subject property within the county is identified 206 as is a pool of comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

The pool of comparable properties may be initially defined using exclusion rules. This limits the unwieldy number of comparables that would likely be present if the entire county level data were included in the modeling of the comparables.

Although a variety of exclusion rules can be used, in one example they may include one or more of the following: (1) limiting the comparable properties to those within the same census tract as the subject property (or, the same census tract and any adjacent tracts); (2) including only comparable properties where the transaction (e.g., sale) is within 12 months of the effective date of the appraisal or transaction (sale); (3) requiring GLA to be within a range including that of the subject property (e.g., +/−50% of the GLA of the subject property); (4) requiring the age of the comparable properties to be within an assigned range as determined by the age of the subject property (e.g., as described previously); and/or (5) requiring the lot size for the comparable properties to be within an assigned range as determined by the lot size of the subject property (e.g., as described previously).

Once the pool is so-limited, a set of adjustment factors is determined 208 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 208, the “economic distance” between the subject property and respective individual comparable properties is determined 210. The economic distance may be constituted as a quantified value representative of the estimated price difference between the two properties as determined from the set of adjustment factors for each of the explanatory variables.

Following determining of the economic distance, the comparable properties may be weighted 212 in support of generating a ranking of the comparable properties according to the model. One example of a weighting entails a function inversely proportional to the economic distance, geographic distance and age of transaction (typically sale) of the comparable property from the subject property.

The weights may further be used to calculate an estimated price of the subject property comprising a weighted average of the adjusted price of all of the comparable properties.

Once the model has performed the regression, adjustments and weighting of comparables, the information is conveyed to the user in the form of grid and map image displays to allow convenient and comprehensive review and analysis of the set of comparables.

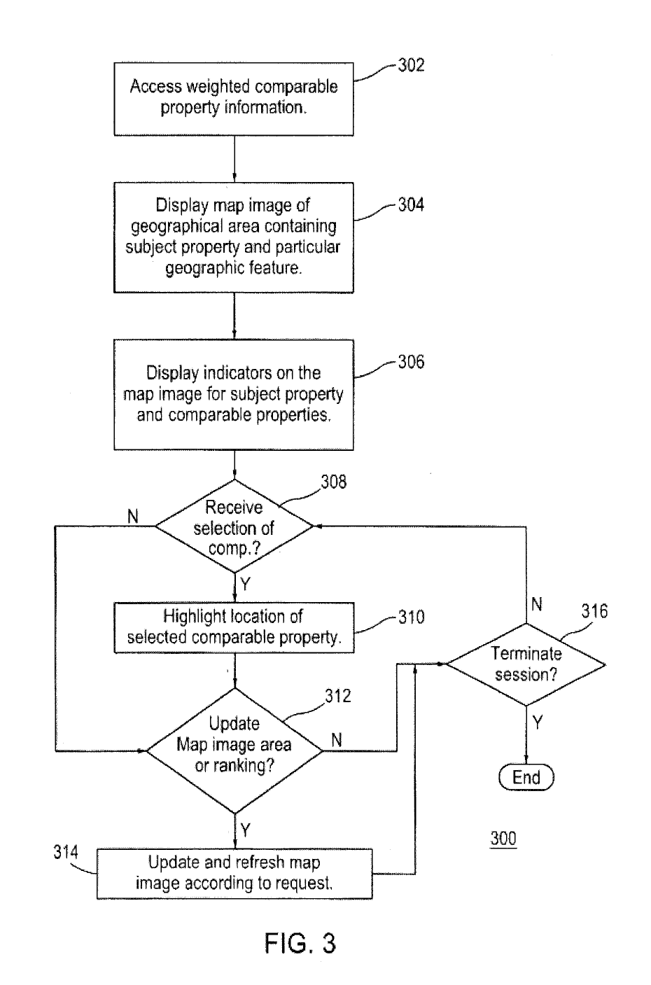

FIG. 3 is a flow diagram illustrating an example of modeling and mapping comparable properties. Specifically, FIG. 3 is a flow diagram illustrating an example of a process 300 for modeling and mapping comparable properties with initial access 302 of the weighted comparable property information. This may be as described above, such as wherein the comparable properties are weighted according to the economic distance, geographic distance and age of transaction information.

The process also includes display 304 of a map image of a geographic area containing the subject property. The map image information may be acquired from mapping resources, including but not limited to Google maps and the like. Additionally, techniques may be used to depict subject and comparable properties on the map image, such as through determination of the coordinates from address information.

The map imagery may be various updated to provide user-desired views, including zooming in and out to provide more narrow or broad perspectives of the depictions of the comparable and subject properties. Additionally, the map imagery is updated to reflect the current display of various geographical features. In one example, a body of water may be depicted as a geographical feature in the map image, along with parcels corresponding to properties. Although one embodiment describes the determination of bordering status for a body of water, embodiments of the invention are not so-limited. For example, the model may implement determinations whether a property borders geographical features including highways or other major roads, parks, golf courses, mass transit, commercial properties/zones, cul-de-sacs, power plants, railroads, garbage dumps, etc.

The property data includes information as to the location of the properties, and either this native data may be used, or it may be supplemented, to acquire that exact location of the subject property and potential comparable properties on the map image. This allows the map image to be populated with indicators that display 306 the location of the subject property and the comparable properties in visually distinguishable fashion on the map image. The number of comparable properties that are shown can be predetermined or may be configurable based upon user preferences. The number of comparable properties that are shown may also update depending upon the level of granularity of the mage image. That is, when the user updates 312 the map image such as by zooming out to encompass a wider geographic area, when the map image updates 314 additional comparable properties may be rendered in addition to those rendered at a more local range.

The user may also prompt a particular comparable property to be highlighted 310, such as by cursor rollover or selection of an entry for the comparable property in a listing. When the application receives 308 an indication that a property has been selected, it is highlighted in the map. Conversely, the user may also select the indicator for a property on the map image, which causes display of the details corresponding to the selected property.

Updating of the map image, highlighting of selected properties, and other review of the property data continues until termination 316 of the current session.

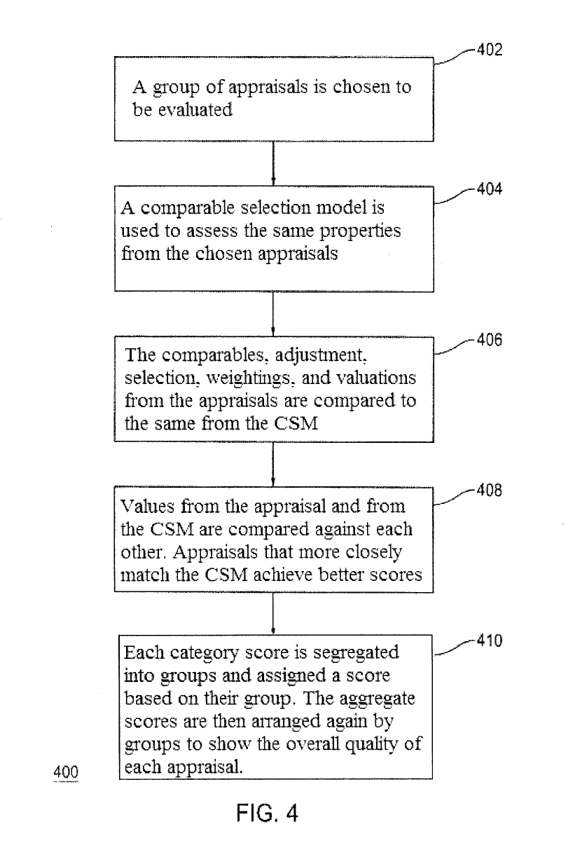

FIG. 4 is a flow diagram illustrating a process for evaluating a group of appraisals and segregating the evaluated appraisals into quintiles. Specifically, FIG. 4 is a flow diagram illustrating a process 400 for evaluating a group of appraisals and segregating 410 the evaluated appraisals into groups. Under process 400, the quality of an appraisal is automatically rated by selecting a set of control comparables from a database and comparing those control comparables to the comparables listed on the appraisal. The comparisons of control and listed comparables themselves generate a quality rating for the appraisal based on category scores, which result from an appraisal evaluation over a set of categories.

That is, to rate the quality of a single appraisal or a group of appraisals, the appraisals themselves must first be chosen 402 to be evaluated. In general, by merely adding an appraisal to a database results in an automatic evaluation and classification, which would permit faster data polling as a scored appraisal would not require the real time processing that an un-scored appraisal would when a user, appraiser, or analyst access the database. Yet, the mere entry of an appraisal into the system may not be the only reason or purpose for parsing though a database of property valuations. Thus, choosing 402 an appraisal may be any one of, but not limited to, a user inputting a set of appraisals, an automatic selection of appraisals based on a default criterion, or a change in evaluation criteria that requires a previously evaluated set of appraisals to be reevaluated. In the case of automatic appraisal selection, a model similar to that of the CSM may be employed where a hedonic equation and regressions are used to retrieve appraisals on relative subjects and properties.

Once an appraisal set is chosen 402, a comparable selection model (CSM) is used to assess 404 the properties from the chosen appraisals. In addition, the CSM selects the best comparable sales for a property using transaction level data and property characteristics, as detailed above. Thus, the application can acquire a control appraisal set that will be used to rate the appraisal presently being evaluated and to rate the comparables listed on that appraisal, while assessing the value of a property or subject.

Next, comparables, adjustments, selections, weightings, and valuations from the appraisals are compared 406 to the same from the CSM, or in other words the evaluation application compares the model sales (control sales chosen 402 by the CSM) to the comparable sales selected for use in an appraisal (listed comparables on the appraisal to be evaluated) based on predefined inputs or categories. The inputs or categories may include comparable selection, comparable weighting, comparable adjustment, and final evaluation, which is a comparison 408 of the values from the appraisal and from the CSM.

### (i) Comp Selection/Comp Weighting

When evaluating an appraisal and its comparables under the comparable selection category, the evaluation application renders a score based on how well the appraisal's comparable sales compare to the model-selected comparable sales in categories that drive the value of properties (i.e. explanatory variables). The explanatory variables may include rank ordering, distance from subject, age of comparable sale, property characteristics, and price distribution.

Rank ordering or relative ranking of appraisal comps considers two measures of rankings of appraisal comps relative to those of other model comps from the CSM. The first is how well CSM ranks the best appraisal comp, i.e., the minimum-ranked sale comp (compsel_1).

compsel_{—}1ᵢ=min(rank_{i,j}|jεJ) (Eq. 9)

The variable rank_{i,j} measures the rank of appraisal sale comp j among all appraisal comps and model comps based on the CSM assigned weights. The CSM actually returns a set of ranks that returns the average of the ranks if there is a tie. For instance, if two sales comps have identical weights and are the best two comps according to the CSM (i.e. receive the highest weights) then the CSM returns ranks of 1.5 and 1.5 for these two comps. For the purposes of compsel_1, however, the comp with the adjusted value closest to the subject's final appraised value is ranked at 1 (i.e. the rank at which the tie occurs). The adjusted value for the comp should be checked to be within a 10 percent variation of the final appraised value, such that the appraiser's best comp should also receive sufficient weight in the appraiser's final valuation.

The second ranking criterion is based on the average weights of appraisal comps versus the average weights of model comps (compsel_2). That is, when evaluating an appraisal and its comparables, the evaluation application weighs comparables more heavily when the comparables more closely match the final valuation of the appraisal. That is, based on A) a comparison of a weighting of each listed comparable and on how closely each listed comparable matches the appraisal valuation to B) a weighting of each control comparable and on how closely each control comparable matches the appraisal valuation, a weighting is calculated for each comparable property and scores are assigned accordingly. Both weights may be assigned by CSM.

$$compsel\_ {2}_{i} = ( \frac{1}{J} {\sum }_{m = 1}^{J} {w}_{i , m}^{*} ) {( \frac{1}{J} {\sum }_{j = 1}^{J} {w}_{i , j} )}^{- 1} - 1 \qquad ( Eq . 10 )$$

The notation convention followed here denotes variables corresponding with model comps by *, and variables corresponding to measures associated with appraisal comps by no *. The variable w_{i,j} measures the normalized weight of appraisal sale comp j for subject i, and w*_{i,m} measures the normalized weight of CSM model comp m that were not used by the appraiser. The number of model comps is limited to top J comps so that the same number of model comps are compared to appraisal comps. Comp selection measure is grouped into 5 different levels with 1 being the best and 5 being the worst. Appraisals with worse comp selection measures are considered less acceptable, because these appraisers overlooked better comps as suggested by the CSM.

Distance from subject or relative geographic distance between subject and appraisal comps (geod) is an explanatory variable, which is defined by the geographic distance between the subject and appraisal comps provided by the appraisal, that can be compared with the geographic distances from the CSM between the subject and model comps. The geographic distance metric used to evaluate appraisal i is given as the average geographic distance of appraisal comps relative to model comps:

$${geod}_{i} = ( \frac{1}{J} {\sum }_{i = 1}^{J} {dgeo}_{i , j} ) {( \frac{1}{J} {\sum }_{m = 1}^{J} {dgeo}_{i , m}^{*} )}^{- 1} - 1 \qquad ( Eq . 11 )$$

The variable dgeo_{i,j} measures the geographic distance between appraisal sale comp j and subject i for the J sale comps, and dgeo*_{i,m} measures the geographic distance between model comp m and subject i. Number of model comps is limited to top J comps so that same number of model comps are compared to appraisal comps. Appraisals with further relative geo distances are considered less desirable, because appraisers overlooked closer and better comps suggested by the CSM.

Age of comparable sale or the relative time lag between subject and appraisal comps (timed) is an explanatory variable that is defined by the time interval between the sale dates of appraisal comps and the appraised date of subject, which can be compared with the time interval from the CSM between the sale dates of model comps and the appraised date of subject. The time distance metric used to evaluate appraisal i is given as the average time elapsed since the sales of appraisal comps relative to the corresponding measure for model comps:

$${timed}_{i} = ( \frac{1}{J} {\sum }_{j = 1}^{J} {dtime}_{i , j} ) {( \frac{1}{J} {\sum }_{m = 1}^{J} {dtime}_{i , m}^{*} )}^{- 1} - 1 \qquad ( Eq . 12 )$$

The variable dtime_{i,j} measures the time elapsed between the sale date of appraisal sale comp j and the appraisal date of subject i for the J sale comps, and dtime*_{i,m} measures the time elapsed between the appraisal date of subject i and the sale date of CSM model comp m that were not used by the appraiser. Number of model comps is limited to top J comps so that same number of model comps are compared to appraisal comps. Appraisals with higher time distances are considered worse appraisals, because those appraisals represent a set of comps that on average transacted further in the past relative than the set of comps suggested by the CSM.

Property characteristics or the relative similarity of property characteristics between subject and appraisal sales comps (ecod) are inputs provided by the CSM that can be used to compute an economic distance measure between the subject and the appraiser's sales comps based only on the physical characteristics of the property. It is basically the geometric mean of adjustments in five characteristics (GLA, lot, age, bedroom and bath).

$${deco}_{i , j} = \sqrt{\begin{matrix}{ADJ\_GLA}_{i , j}^{2} + {ADJ\_LOT}_{i , j}^{2} + \\ {ADJ\_AGE}_{i , j}^{2} + {ADJ\_BED}_{i , j}^{2} + {ADJ\_BTH}_{i , j}^{2}\end{matrix}} \qquad ( Eq . 13 )$$

Here, ADJ_GLA_{i,j} represents the gross living area (GLA) adjustment between subject i and sales comp j (j=1, . . . , J). The remaining terms ADJ_LOT_{i,j}, ADJ_AGE_{i,j}, ADJ_BED_{i,j} and ADJ_BTH_{i,j} are defined analogously as the adjustments between the subject and comp pair along the respective dimensions of lot size (LOT), age of the property (AGE), number of bedrooms in the property (BED) and number of bathrooms in the property (BTH). The average of these economic distances can be compared with the average of the economic distance measures between the top J model comps not chosen by the appraiser and the subject (deco*_{i,m}, m=1, . . . , J). The economic distance measure for appraisal (and subject) i is given as:

$${ecod}_{i} = \frac{1}{J} {\sum }_{j = 1}^{J} {deco}_{i , j} - \frac{1}{J} {\sum }_{m = 1}^{J} {deco}_{i , m}^{*} \qquad ( Eq . 14 )$$

Appraisals with higher economic distances are considered less desirable, because these appraisals have overlooked comps more dissimilar to the subject suggested by the CSM.

Price distribution or the relative price distribution or market segmentation of appraisal sales comps (amtd) is an evaluation of the price distribution of the appraisal sale comps along two dimensions.

The first is the average sales price of appraisal comps relative to model comps:

$$amtd\_ {1}_{i} = ( \frac{1}{J} {\sum }_{j = 1}^{J} {amt}_{i , j} ) {( \frac{1}{J} {\sum }_{m = 1}^{J} {amt}_{i , m}^{*} )}^{- 1} - 1 \qquad ( Eq . 15 )$$

The variable amt_{i,j} the sales price of appraisal sale comp j for appraisal i for the J sale comps, and amt*_{i,m} measures the sales price of CSM model comp m for the top J model comps that were not chosen by the appraiser. Appraisals with higher amtd_1_{i,j} price distribution measures are considered less desirable, because these appraisals have chosen more high-priced comps than representative comps suggested by the CSM.

The second price distribution measure is the range of appraisal comp price:

amtd_{—}2ᵢ=(max(amt_{i,j}|jεJ)−min(amt_{i,j}|jεJ))/min(amt_{i,j}|jεJ)′ (Eq. 16)

Wider range indicates less comparability or similarities among appraisal comps and thus the appraisal is inferior.

### (ii) Comp Adjustment

The next component of the appraisal scorecard involves the adjustment of comp values by the appraiser. That is, when evaluating an appraisal and its comparables, the evaluation application measures the comparable adjustments in appraisals relative to adjustments from the CSM by generating a lower score for greater differences in the magnitude for the respective adjustments. The relative adjustment metric compares an appraiser's adjustment for a sales comp versus that suggested by the CSM for the same sales comp:

$${compadj}_{i} = ( \frac{1}{J} {\sum }_{j = 1}^{J} \frac{{adj\_amt}_{i , j}}{{csm\_amt}_{i , j}} ) - 1 \qquad ( Eq . 17 )$$

The variables adj_amt_{i,j} and csm_amt_{i,j} represent, respectively, the appraiser's adjusted value and the adjusted value reported by the CSM of sale comp j in appraisal i.

Higher values of this measure are indicative of lower quality appraisals. This measure The next component of the appraisal scorecard involves the adjustment of comp values by the appraiser. The comparable adjustments category captures two potential sources of appraisal error: (1) adjustments that are too large and boosting the adjusted price of sales comps beyond what is supported by the evidence and (2) adjustments that are too small and keep the adjusted price of sales comps higher than is supported by the evidence.

(iii) Final Valuation/Appraisal Bias

When evaluating an appraisal and its comparables under the final valuation category, the evaluation application compares 408 the final valuation from the appraisal to the comparables listed on that appraisal. Further, the evaluation application compares the control comparable to the final valuation of the subject rendered by CSM, such that the valuation bias or final valuation of the appraisals (or the CSM) that more closely match the valuation bias of the comparables listed on the appraisals (or the control comparables) may receive higher scores. In other words, the evaluation application compares the control comparables to a set of listed comparables to generate a quality rating for the appraisal based on category scores, wherein the set of listed comparables are the comparables itemized on the appraisal being automatically rated, and wherein category scores result from an appraisal evaluation over a set of categories.

The valuation bias of an appraisal is defined as the appraised value divided by CSM prediction minus 1:

csm_{—}biasᵢ=(subj_{—}amtᵢ−csm_{—}subj_{—}amtᵢ)/csm_{—}subj_{—}amtᵢ (Eq. 18)

Appraisals with higher biases are considered worse appraisals, as their valuations are further from the values suggested by the CSM. If, the appraiser follows good practice and scores well on the other major components of comp selection, comp adjustment and comp weighting then the likelihood that the final valuation will disagree with the prediction of the CSM is lower. It is possible, however, that an otherwise flawed appraisal along one of these dimensions can still produce an appropriate valuation and an appropriate combined loan-to-value measure. This appropriately valued appraisal, despite being flawed, provides less risk than an overvalued appraisal. Therefore, valuation bias is used as a severity or significance check. The evaluation application would thus judge an appraisal with a given selection, weighting, or adjustment defect and an inappropriate final valuation more harshly than an appraisal with the same given defect and an appropriate final valuation, such that appraisals that more closely match the CSM achieve better scores. Once the scores and weightings are rendered, each category score is then segregated 410 into groups and assigned a score based on their group. The aggregate scores are then arranged again by groups to show the overall quality of each appraisal.

For example, each category may be segregated into five categories, for instance quintiles or a user-determined subgroup, and assigned numbered scores based on those five categories (i.e. 1 to 5). The individual scores are then aggregated using a weighted average into an overall score:

$${appr\_score}_{i} = {w}_{1} * compsel\_ {1}_{i} + {w}_{2} * compsel\_ {2}_{i} + {w}_{3} * {geod}_{i} + {w}_{4} * {timed}_{i} + {w}_{5} * {ecod}_{i} + {w}_{6} * amtd\_ {1}_{i} + {w}_{7} * amtd\_ {2}_{i} + {w}_{8} * {csm\_bias}_{i} \qquad ( Eq . 19 )$$

The resulting score is arranged again into five categories to show the overall quality of each appraisal. For example, for each given appraisal, the invention produces a score from 1 (best) to 5 (worst) using inputs (categories scores and other data) from a comparable selection model (CSM) and the 1004 uniform Residential Form (appraisal).

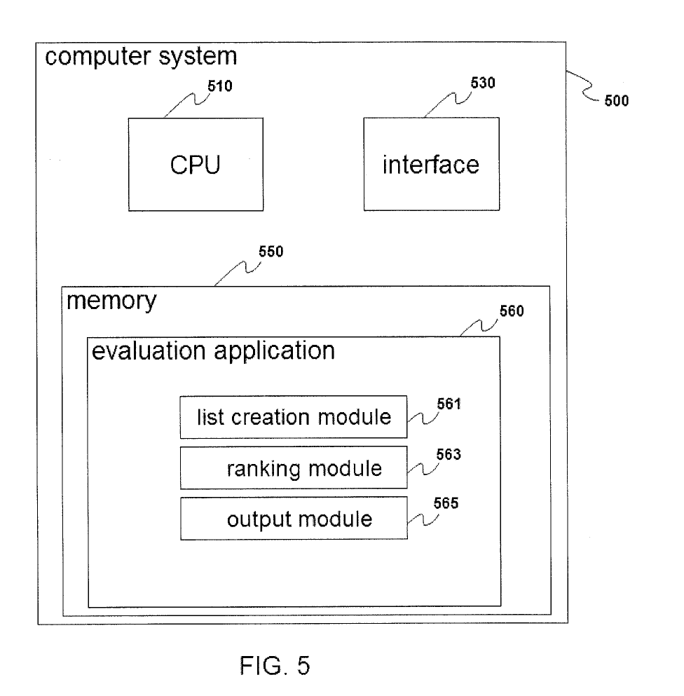

FIG. 5 is a block diagram illustrating an example of an evaluation application. Specifically, FIG. 5 is a block diagram illustrating an example of a computer system 500 in which the evaluation application 560 operates. FIG. 5 illustrates a computer system 500, which includes a central processing unit (CPU) 510, an interface 530, and a memory 550. The computer system 500 may be a conventional desktop computer, a network computer, a laptop personal computer, a handheld portable computer (e.g., tablet, PDA, cell phone) or any of various execution environments that will be readily apparent to the artisan and need not be named herein. The interface 530 may be any interface suited for input and output of communication data, whether that communication is visual, auditory, electrical, transitive, or the like. In addition, devices 102a-c and 106a-c may be similarly configured to the above described computer system 500.

The computer system 500 runs a conventional operating system through the interaction of the CPU 510 and the memory 550 to carry out functionality by execution of computer instructions. The memory 550 may be any memory suitable for storing data, such as any volatile or non-volatile memory, whether virtual or permanent. Operating systems may include but are not limited to Windows, Unix, Linux, and Macintosh. The computer system may further implement applications that facilitate calculations including but not limited to MATLAB. The artisan will readily recognize the various alternative programming languages and execution platforms that are and will become available, and the present invention is not limited to any specific execution environment.

In one embodiment, a computer system 500 includes the evaluation application 560 resident in memory 550, with the evaluation application 560 including instructions that are executed by a CPU 510. That is, the evaluation application 560 is preferably provided as software, yet it may alternatively be hardware, firmware, or any combination of software, hardware and firmware. Alternative embodiments include an article of manufacture wherein the instructions are stored on a computer readable storage medium. The medium may be of any type, including but not limited to magnetic storage media (e.g., floppy disks, hard disks), optical storage media (e.g., CD, DVD), and others. Still other embodiments include computer implemented processes described in connection with the comparable rating application 160 as well as the corresponding flow diagrams.

The evaluation application 560, according to the present invention, may have a list creation module 561, a ranking module 563, and an output module 565 to implement an appraisal rating. Further, other application modules not shown in FIG. 5, but described through the specification, may also be implemented.

The list creation module 561 may select control comparables based on a subject using its own internal CSM or communicate via the interface 530 with an external comparable selection model to select said control comparables. Further, the list creation model may add the appraisal selected comparables to the control comparables.

The ranking module 563 may rank the comparable list constructed by the list creation module using category comparisons. The output module 565 may output the ranked list to a display device that is either internal or external to the computer system 500. The display device may further be any device that displays an image to a user, such as a light-emitting diode display, a liquid crystal display, an organic light-emitting diode display, a plasma display, and a cathode-ray display.

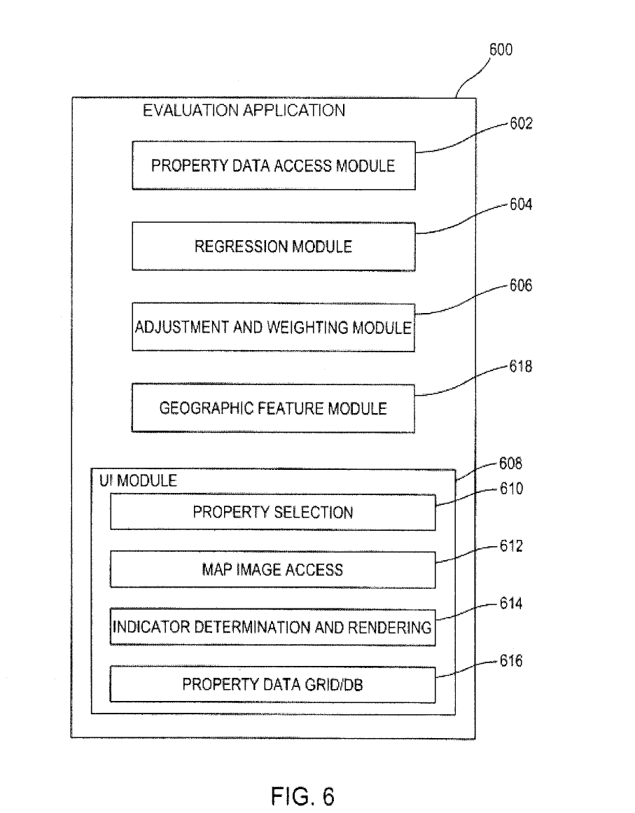

FIG. 6 is a block diagram illustrating an example of an evaluation application with geographic feature proximity determination. Specifically, FIG. 6 is a block diagram illustrating an example of an evaluation application 600. The application 600 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of accessing property data corresponding to a geographic area, and performing a regression based upon the property data, with the regression modeling the relationship between price and explanatory variables. A subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The application 600 also includes program code for displaying a map image corresponding to the geographic area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The evaluation application 600 is preferably provided as software, but may alternatively be provided as hardware or firmware, or any combination of software, hardware and/or firmware. The application 600 is configured to provide the comparable property modeling and mapping functionality described herein. Although one modular breakdown of the application 600 is offered, it should be understood that the same functionality may be provided using fewer, greater or differently named modules.

The example of the evaluation application 600 of FIG. 6 includes a property data access module 602, regression module 604, adjustment and weighting module 606, geographic feature module 618, and UI module 608, with the UI module 608 further including a property selection module 610, map image access module 612, indicator determining and rendering module 614 and property data grid/DB module 616.

The property data access module 602 includes program code for carrying access and management of the property data, whether from internal or external resources. The regression module 604 includes program code for carrying out the regression upon the accessed property data, according to the regression algorithm described above, and produces corresponding results such as the determination of regression coefficients and other data at the country (or other) level as appropriate for a subject property. The regression module 604 may implement any conventional code for carrying out the regression given the described explanatory variables and property data.

The adjustment and weighting module 606 is configured to apply the exclusion rules, and to calculate the set of adjustment factors for the individual comparables, the economic distance, and the weighting of the comparables.

The geographic feature module 618 manages the identification of geographic features, processing of rendered shapes for the geographic features, and application of logic and corresponding determinations whether properties are proximate to the geographic features, such as through the functionality described in connection with FIGS. 4-5 above.

The UI module 608 manages the display and receipt of information to provide the described functionality. It includes a property selection module 610, to manage the interfaces and input used to identify one or more subject properties, from which a determination of the corresponding geographic area is determined in support of defining the scope of the regression and other functionality. The map image access module 612 accesses mapping functions and manages the depiction of the map images as well as the indicators of the subject property and the comparable properties. The indicator determination and rendering module 614 is configured to manage which indicators should be indicated on the map image depending upon the current map image, the weighted ranking of the comparables and predetermined settings or user input. The property data grid/DB 616 manages the data set corresponding to a current session, including the subject property and pool of comparable properties. It is configured as a database that allows the property data for the properties to be displayed in a tabular or grid format, with various sorting according to the property characteristics, economic distance, geographic distance, time, etc.

### Evaluation Application Example

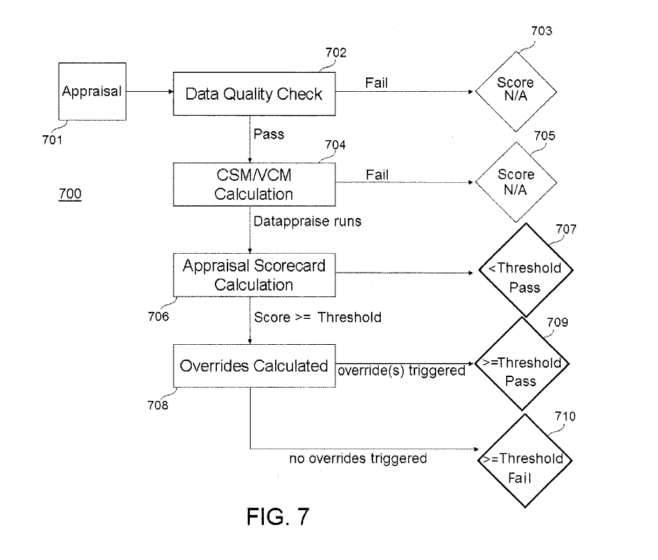

FIG. 7 is a block diagram illustrating an example of an evaluation application process. Specifically, FIG. 7 is a block diagram illustrating an example of an evaluation application process or an appraisal scorecard algorithm 700. Appraisal(s) 701 must pass a data quality check 702 or data integrity check to be eligible for an appraisal score and pass/fail decision. This data quality check ensures that the appraisal form was adequately prepared, that the data is complete and reasonable. For those appraisals designated not as having sufficient quality, a score is not rendered 703.

For those appraisals designated as having sufficient quality, the appraisal is run through the CSM/VCM process or a calculation 704 of CSM and VCM (a.k.a. ‘datappraise’). This creates the model-based CSM and VCM measures to be used later in the appraisal scoring process. If the ‘datappraise’ is unable to run with at least a given number of comps (total of model and appraisal comps), the appraisal does not receive 705 a score or pass/fail designation. However, if the appraisals are able to be ‘datappraised’ with at least a given number of comps the appraisal score is calculated 706. This results in a score ranging from 1-5. Those appraisals scoring at or above a given threshold, are given a preliminary designation of “FAIL.” The remaining scored appraisals (i.e. score<threshold) are given a “PASS” 707.

For those appraisals scoring at or above a given threshold and given a preliminary designation of “FAIL,” overrides 708 are applied to those appraisals and a “PASS” designation 709 given if any of the overrides are triggered. The overrides may include: 1) Low VCM-calculated confidence; 2) Water-affected property; 3) Insufficient valuation risk; 4) Comp with sufficient rank and weight; 5) Sufficient average comp rank; 6) Sufficiently comparable properties selected; 7) Sufficiently acceptable adjustment made; and 8) CSM crosses highways, while appraiser does not. If none of the above overrides are triggered, the appraisal designation 710 remains “FAIL.”

For example, if the number of given comps is ten and the ‘datappraise’ is unable to run with at least ten comps, the appraisal does not receive a score or pass/fail designation. However, if the appraisals are able to be ‘datappraised’ with at least ten comps an appraisal score ranging from 1-5 is calculated. Further, if the threshold is 3.6, appraisals scoring lower than 3.6 are given a designation of “PASS.” The remaining scored appraisals (i.e. score>=3.6) are given a preliminary designation of “FAIL” and overrides are applied. A “PASS” designation then given if any of the overrides are triggered.

### Displaying

According to another aspect, mapping and analytical tools that implement the evaluation application are provided. Mapping features allow the subject property and comparable properties to be concurrently displayed. Additionally, a table or grid of data for the subject properties is concurrently displayable so that the list of comparables can be manipulated, with the indicators on the map image updating accordingly.

For example, mapping features include the capability to display the boundaries of census units, school attendance zones, neighborhoods, as well as statistical information such as median home values, average home age, etc. The mapping features also accommodate the illustration of geographical features of interest along comparable properties, offering visual depiction of properties that border the feature.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

Thus, embodiments of the described produce and provide methods and apparatus for a model for evaluating appraisals by comparing their comparable sales with selected comparable sales. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for an automatic quality rating of appraisal selected comparables, comprising:
creating a comparable list by:
selecting by a comparable selection model control comparables based on a subject, and
adding the appraisal selected comparables to the control comparables;
ranking the comparable list using category comparisons; and
displaying the ranked list via a display device.

2. The method of claim 1, wherein the comparable selection model selects the set of control comparables using transaction data and property characteristics relative to the subject.

3. The method of claim 1, wherein ranking the comparable list using category comparisons, comprises:
generating for each comparable in the comparable list set of scores where each score is relative to a category in a category set,
wherein the category set includes comparable selection, comparable adjustment, comparable weighting, and final valuation.

4. The method of claim 3, wherein generating the category score for the comparable selection category is based on how closely the control comparables and the appraisal selected comparables match in terms of explanatory variables.

5. The method of claim 4, wherein the explanatory variables include property characteristics, distance from subject, age of comparable sale, price distribution, and rank ordering.

6. The method of claim 3, wherein generating the category score for the comparable adjustment category is based on the difference between adjustments made to the appraisal selected comparables and adjustments made by the comparable selection model to the control comparables.

7. The method of claim 3, wherein generating the category score for the comparable weighting category is based on a comparison of
a weighting of each appraisal selected comparable based on how closely each appraisal selected comparable matches an appraisal valuation to
a weighting of each control comparable based on how closely each control comparable matches the appraisal valuation.

8. The method of claim 3, wherein generating the category value for the final valuation category is based on how closely
a final valuation of the subject by the appraisal using the appraisal selected comparables matches
a final valuation of the subject by the comparable selection model using the control comparables.

9. The method of claim 1, further comprising:
automatically rating a quality of each appraisal in a set of appraisals,
wherein each appraisal of the set of appraisals is segregated based on its respective quality rating into groups, and
wherein the segregating is based on the automatic quality rating of appraisal selected comparables.

10. The method of claim 1, wherein the display device is selected from a set of display devices that includes a light-emitting diode display, a liquid crystal display, an organic light-emitting diode display, a plasma display, and a cathode-ray display.

11. The method of claim 1, wherein the display device is connected to an electronic device,
wherein electronic device is selected from a set of electronic devices that includes personal computers, laptop personal computers, mobile phones, smart-phones, super-phones, tablet personal computers, and personal digital organizers.

12. A computer program product stored on a non-transitory computer readable medium that when executed by a computer performs a method for automatically rating a quality of an appraisal, the method comprising:
creating a comparable list by:
selecting by a comparable selection model control comparables based on a subject, and
adding the appraisal selected comparables to the control comparables;
ranking, by the computer, the comparable list using category comparisons; and
displaying the ranked list via a display device.

13. A method for an automatic quality rating of appraisal selected comparables, comprising:
means for creating a comparable list by:
selecting by a comparable selection model control comparables based on a subject, and
adding the appraisal selected comparables to the control comparables;
means for ranking the comparable list using category comparisons; and displaying the ranked list via a display device.

14. An apparatus that automatically rates a quality of appraisal selected comparables, comprising:
a circuit that creates a comparable list by selecting control comparables based on a subject via a comparable selection model, extracting the appraisal selected comparables from an appraisal, and adding the appraisal selected comparables to the control comparables, and that ranks the comparable list using category comparisons; and
a display that displays the ranked list.

15. A method for rendering an appraisal scorecard, comprising:
receiving an appraisal;
executing a data integrity check on the appraisal;
evaluating the appraisal if the appraisal passes the data integrity check by running the appraisal through a comparable selection model and a value confidence model; and
rating the appraisal based on the appraisal evaluation and pass/fail thresholds,
wherein evaluating the appraisal includes generating for each comparable identified by the comparable selection model and the value confidence model scores that are relative to a category set, which includes comparable selection, comparable adjustment, comparable weighting, and final valuation.
